(19) United States
(12) Patent Application Publication
(10) Pub. No.: US 2008/0273799 A1
(43) Pub. Date: Nov. 6, 2008

(54) INFORMATION PROCESSING APPARATUS, INFORMATION PROCESSING METHOD, PROGRAM, AND PROGRAM STORAGE MEDIUM

(75) Inventor: Norihiko Kimura, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/876,321

(22) Filed: Oct. 22, 2007

(30) Foreign Application Priority Data
Nov. 6, 2006 (JP) 2006-300633

(51) Int. Cl. G06K 9/50

(52) U.S. Cl. 382/200; 382/195; 382/199

(57) ABSTRACT

An information processing apparatus including a function of processing images is provided. The information processing apparatus includes a bitmap data obtaining unit configured to obtain bitmap data; a pixel extracting unit configured to extract, from the bitmap data obtained by the bitmap data obtaining unit, pixels on the basis of circumference of circles of a predetermined radius that would be drawn from the center of graphic pixels constituting a character or an image, and regard the pixels as extracted pixels; a pixel value giving unit configured to give a predetermined pixel value to the pixels extracted by the pixel extracting unit; and a first combining unit configured to combine the extracted pixels to which the pixel value has been given by the pixel value giving unit and the bitmap data obtained by the bitmap data obtaining unit so as to obtain bitmap data with an effect.

### CROSS REFERENCES TO RELATED APPLICATIONS

The present invention contains subject matter related to Japanese Patent Application JP 2006-300633 filed in the Japanese Patent Office on Nov. 6, 2006, the entire contents of which are incorporated herein by reference.

### BACKGROUND OF THE INVENTION

1. Field of the Invention

The present invention relates to an information processing apparatus, an information processing method, a program, and a program storage medium. Particularly, the present invention relates to an information processing apparatus, an information processing method, a program, and a program storage medium that are preferably used for dealing with bitmap data.

2. Description of the Related Art

When a bitmap image in a bitmap font is superimposed on another image or a frame image constituting moving images, the bitmap image is difficult to be seen if the color of pixels constituting the bitmap image is approximate to the color of a background portion.

For example, Patent Document 1 (Japanese Unexamined Patent Application Publication No. 4-118694) discloses a technique of generating an outline character pattern. In this technique, an outline character pattern is not prepared, but an entire normal character pattern is shifted by one dot in the upper, lower, right, and left directions, the color of dots of the OR thereof is reversed, and the original character pattern is superimposed thereon, so that characters in sentences that are difficult to be read are outlined and can be easily read.

Also, the following techniques have been suggested as similar techniques: a technique of adding outline dots (the width of the outline is one dot) around the dots constituting a character pattern; and a technique of enlarging a character pattern, changing the enlarged pattern to an outline pattern, and superimposing the original character pattern on the outline pattern.

On the other hand, Patent Document 2 (Japanese Unexamined Patent Application Publication No. 10-228268) discloses the following technique. That is, in order to form outline dots around a character portion of a bitmap font having character dots and background dots, four pixels on the upper, lower, right, and left sides of a target pixel are regarded as outline dots, or eight pixels including the above-described four pixels and four pixels on the diagonals of the target pixel are regarded as outline dots. Alternatively, outline dots having an outline width of a plurality of dots are formed by combining the above-described dots.

### SUMMARY OF THE INVENTION

In the technique according to the above-described Patent Document 1, however, the outline is rough at corners of characters. Also, in the case where outline dots are added around the dots constituting a character pattern, the outline is rough at curve and corner portions of the original character if the outline width is wide.

Also, in the case where a character pattern is enlarged, the enlarged pattern is changed to an outline pattern, and the original character pattern is superimposed on the outline pattern by using a bitmap, a portion of rough outline is likely to occur because the outline becomes unclear by enlarging the original character pattern, which is a bitmap.

Also, in the case where four pixels on the upper, lower, right, and left sides of a target pixel are used as an outline or where eight pixels on the upper, lower, right, and left sides and on the diagonals of the target pixel are used as an outline, a natural outline portion and an unnatural outline portion can be generated depending on the four or eight pixels used as the outline and a position in each character (e.g., a corner portion or a curve portion). For example, when the surrounding four pixels are used as the outline, it is possible that a corner portion is not sufficiently drawn. On the other hand, when the surrounding eight pixels are used as the outline, it is possible that a corner of the outline is too much emphasized or that the outline width in a diagonal portion is wide.

The present invention has been made in view of these circumstances and is directed to giving a natural effect to the periphery of bitmap data without performing a complicated process.

According to an embodiment of the present invention, there is provided an information processing apparatus including a function of processing images. The information processing apparatus includes bitmap data obtaining means for obtaining bitmap data; pixel extracting means for extracting, from the bitmap data obtained by the bitmap data obtaining means, pixels on the basis of circumference of circles of a predetermined radius that would be drawn from the center of graphic pixels constituting a character or an image, and regarding the pixels as extracted pixels; pixel value giving means for giving a predetermined pixel value to the pixels extracted by the pixel extracting means; and first combining means for combining the extracted pixels to which the pixel value has been given by the pixel value giving means and the bitmap data obtained by the bitmap data obtaining means so as to obtain bitmap data with an effect.

The information processing apparatus may further include edge pixel extracting means for extracting, from among the graphic pixels, edge pixels each being in contact with a non-graphic pixel on at least one of four sides of upper, lower, right, and left with respect to a main scanning direction. The pixel extracting means may extract, from among the graphic pixels, pixels on the basis of circumference of the circles of a predetermined radius that would be drawn from the center of the edge pixels extracted by the edge pixel extracting means, and regard the pixels as the extracted pixels.

The information processing apparatus may further include second combining means for combining the bitmap data with an effect obtained through combining by the first combining means and other image data.

The information processing apparatus may further include bitmap data generating means for obtaining information required for generating the bitmap data and generating the bitmap data. The bitmap data obtaining means may obtain the bitmap data generated by the bitmap data generating means.

The bitmap data may be bitmap font data, and the information required for generating the bitmap data may be text data and font data.

The pixel extracting means may include holding means for holding table information including information of at least part of coordinates of a circle having a radius of a basic unit length. The pixel extracting means may extract pixels on the basis of circumference of the circles of a predetermined radius that would be drawn from the center of the graphic pixels in accordance with the table information held by the holding means.

The pixel extracting means may extract pixels of which entire part is included in the circles of a predetermined radius that would be drawn from the center of the graphic pixels and regard the pixels as the extracted pixels.

The pixel extracting means may extract pixels of which at least a part is included in the circles of a predetermined radius that would be drawn from the center of the graphic pixels and regard the pixels as the extracted pixels.

The pixel extracting means may extract pixels of which a predetermined percentage or more of area is included in the circles of a predetermined radius that would be drawn from the center of the graphic pixels and regard the pixels as the extracted pixels.

According to an embodiment of the present invention, there is provided an information processing method for an information processing apparatus including a function of processing images. The information processing method includes obtaining bitmap data and extracting graphic pixels constituting a character or an image from the bitmap data; extracting pixels on the basis of circumference of circles of a predetermined radius that would be drawn from the center of the graphic pixels and regarding the pixels as extracted pixels; giving a predetermined pixel value to the extracted pixels; and combining the extracted pixels to which the pixel value has been given and the bitmap data.

According to an embodiment of the present invention, there is provided a program allowing a computer to execute a process of images. The program allows the computer to execute a process of controlling obtainment of bitmap data and extracting graphic pixels constituting a character or an image from the bitmap data; extracting pixels on the basis of circumference of circles of a predetermined radius that would be drawn from the center of the graphic pixels and regarding the pixels as extracted pixels; giving a predetermined pixel value to the extracted pixels; and controlling combining of the extracted pixels to which the pixel value has been given and the bitmap data.

With the above-described configuration, bitmap data is obtained, graphic pixels constituting a character or an image are extracted from the bitmap data, pixels are extracted on the basis of circumference of circles of a predetermined radius that would be drawn from the center of the graphic pixels and the pixels are regarded as extracted pixels, a predetermined pixel value is given to the extracted pixels, and the extracted pixels to which the pixel value has been given are combined with the bitmap data.

In this specification, the network means a system including at least two apparatuses connected to each other so that information can be transmitted from one of the apparatuses to the other. The apparatuses communicating with each other via the network may be apparatuses independent from each other or may be inner blocks constituting an apparatus.

In this specification, the communication includes wireless communication, wired communication, and a combination of wireless and wired communications. For example, wireless communication may be performed in a section and wired communication may be performed in another section. Also, communication from a first apparatus to a second apparatus may be performed with wire, whereas communication from the second apparatus to the first apparatus may be performed wirelessly.

In this specification, the reproducing apparatus may be an independent apparatus or may be a block performing a reproducing process in a recording and reproducing apparatus or an information processing apparatus.

As described above, according to an embodiment of the present invention, an effect can be given to bitmap data. Particularly, a natural effect of outline or the like can be given to bitmap data in a curve or a corner without performing a complicated process.

### BRIEF DESCRIPTION OF THE DRAWINGS

FIG. 1 is a block diagram showing a configuration of a reproducing apparatus;

FIG. 2 illustrates an image-with-effect generating unit shown in FIG. 1;

FIG. 3 illustrates edge pixels;

FIG. 4 illustrates an effect-given-pixel extracting unit shown in FIG. 2;

FIG. 5 illustrates a table held in a table holding unit shown in FIG. 4;

FIG. 6 illustrates pixels to be extracted;

FIGS. 7A and 7B illustrate extraction of pixels and giving of a pixel value;

FIG. 8 illustrates extraction of pixels and giving of a pixel value;

FIGS. 9A to 9D illustrate extraction of pixels and giving of a pixel value;

FIGS. 10A to 10C illustrate combining of bitmap data;

FIG. 11 illustrates an example of giving an effect to a bitmap image;

FIG. 12 is a flowchart illustrating a reproducing process;

FIG. 13 is a flowchart illustrating a process of giving an effect to bitmap data;

FIG. 14 is a block diagram showing a configuration of a personal computer; and

FIG. 15 illustrates an image processing unit shown in FIG. 14.

### DESCRIPTION OF THE PREFERRED EMBODIMENTS

Before describing an embodiment of the present invention, the correspondence between the features of the claims and the specific elements disclosed in an embodiment described in the specification or drawings is discussed below. This description is intended to assure that an embodiment supporting the claimed invention is described in the specification or drawings. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

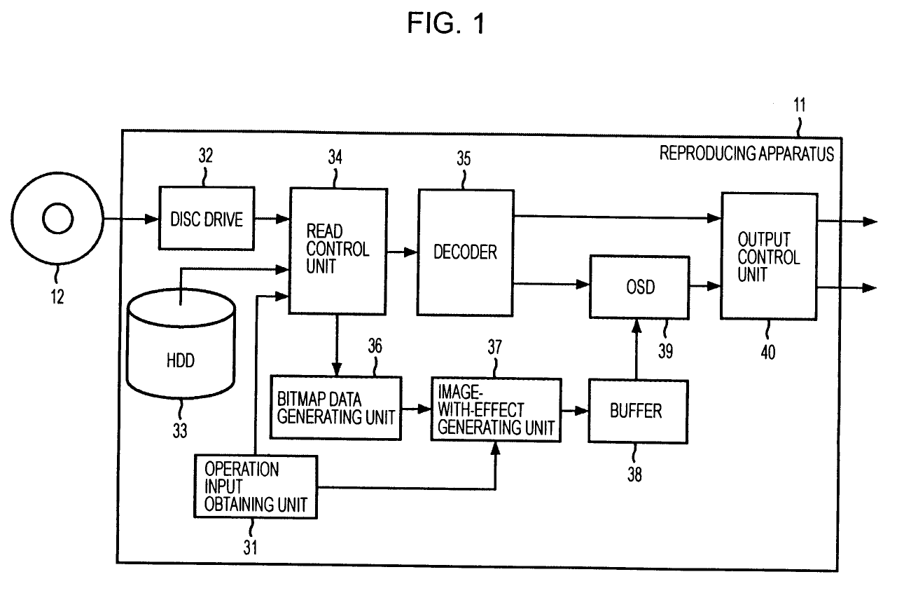

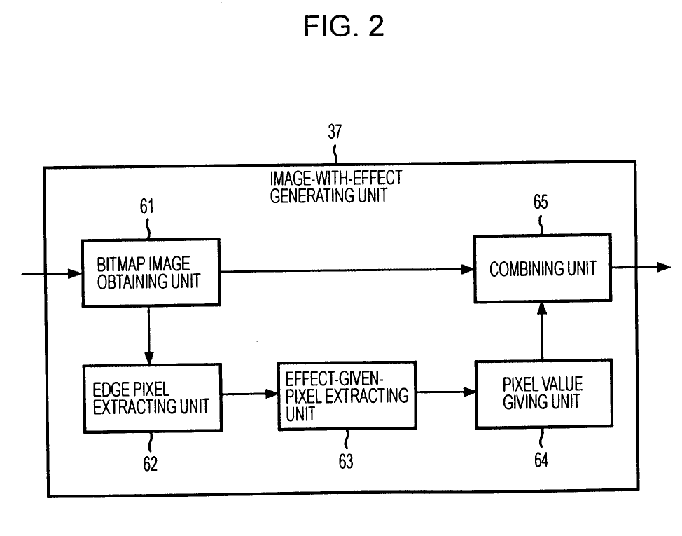

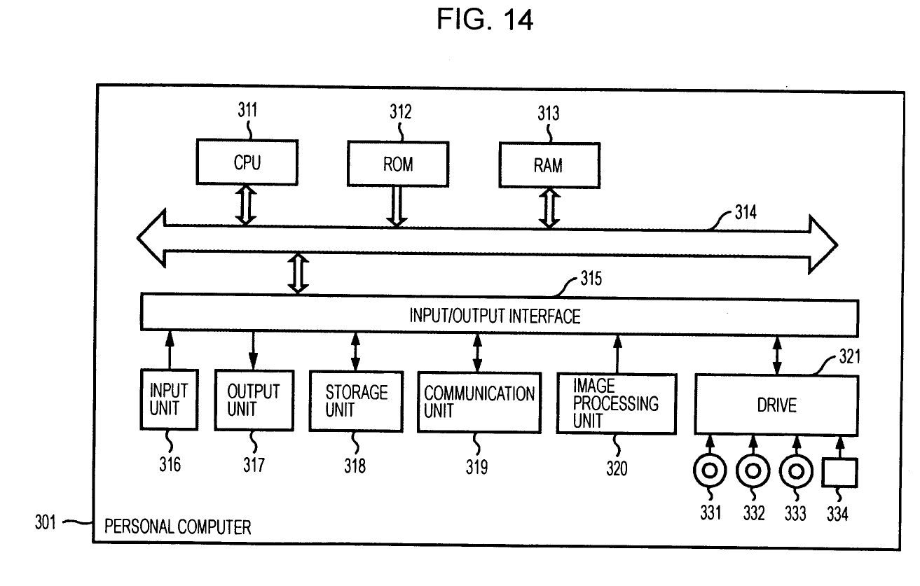

An information processing apparatus according to an embodiment of the present invention is an information processing apparatus (e.g., the reproducing apparatus 11 shown in FIG. 1 or the personal computer 301 shown in FIG. 14) including a function of processing images. The information processing apparatus includes bitmap data obtaining means (e.g., the bitmap image obtaining unit 61 shown in FIG. 2) for obtaining bitmap data; pixel extracting means (e.g., the effect-given-pixel extracting unit 63 shown in FIG. 2) for extracting, from the bitmap data obtained by the bitmap data obtaining means, pixels on the basis of circumference of circles of a predetermined radius that would be drawn from the center of graphic pixels constituting a character or an image, and regarding the pixels as extracted pixels; pixel value giving means (e.g., the pixel value giving unit 64 shown in FIG. 2) for giving a predetermined pixel value to the pixels extracted by the pixel extracting means; and first combining means (e.g., the combining unit 65 shown in FIG. 2) for combining the extracted pixels to which the pixel value has been given by the pixel value giving means and the bitmap data obtained by the bitmap data obtaining means so as to obtain bitmap data with an effect.

The information processing apparatus may further include edge pixel extracting means (e.g., the edge pixel extracting unit 62 shown in FIG. 2) for extracting, from among the graphic pixels, edge pixels each being in contact with a non-graphic pixel on at least one of four sides of upper, lower, right, and left with respect to a main scanning direction. The pixel extracting means may extract, from among the graphic pixels, pixels on the basis of circumference of the circles of a predetermined radius that would be drawn from the center of the edge pixels extracted by the edge pixel extracting means, and regard the pixels as the extracted pixels.

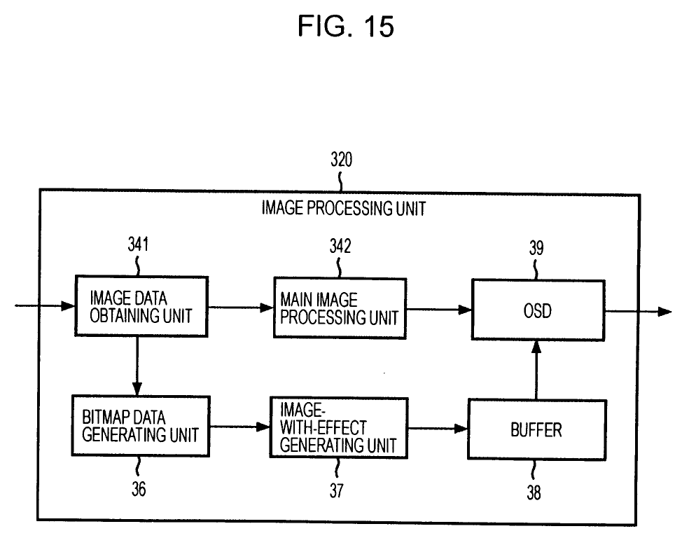

The information processing apparatus may further include second combining means (e.g., the OSD 39 shown in FIG. 1 or 15) for combining the bitmap data with an effect obtained through combining by the first combining means and other image data.

The information processing apparatus may further include bitmap data generating means (e.g., the bitmap data generating unit 36 shown in FIG. 1 or 15) for obtaining information required for generating the bitmap data and generating the bitmap data. The bitmap data obtaining means may obtain the bitmap data generated by the bitmap data generating means.

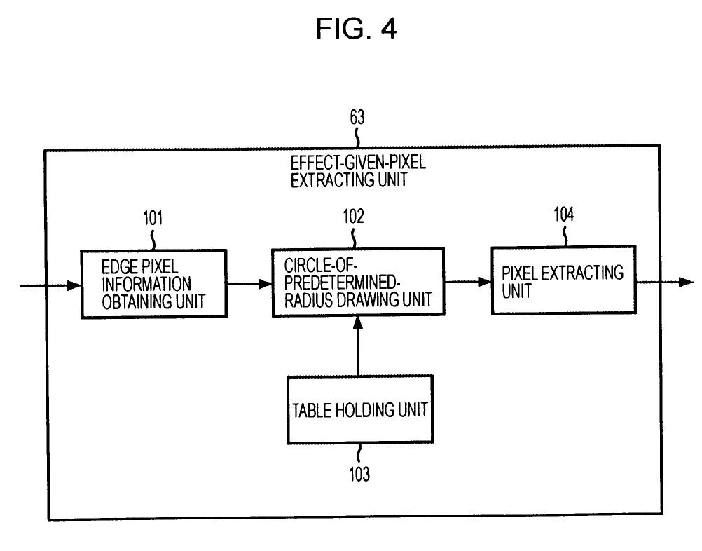

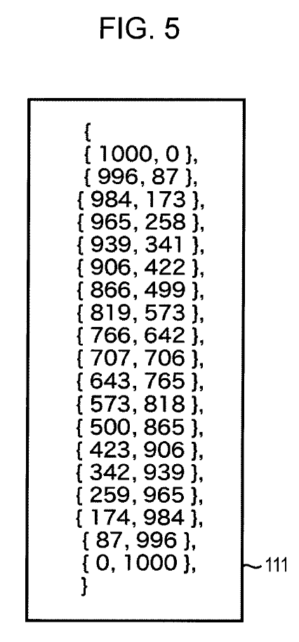

The pixel extracting means may include holding means (e.g., the table holding unit 103 shown in FIG. 4) for holding table information (e.g., the table 111 shown in FIG. 5) including information of at least part of coordinates of a circle having a radius of a basic unit length. The pixel extracting means may extract pixels on the basis of circumference of the circles of a predetermined radius that would be drawn from the center of the graphic pixels in accordance with the table information held by the holding means.

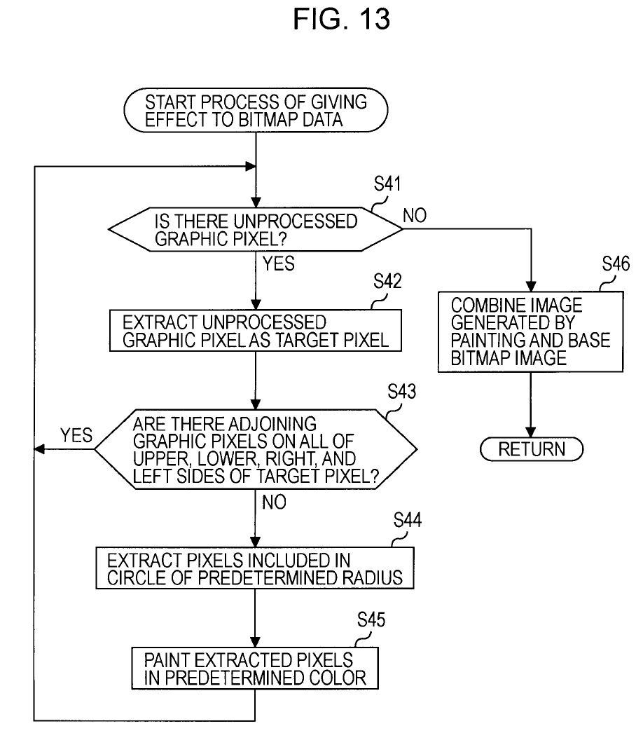

An information processing method according to an embodiment of the present invention is an information processing method for an information processing apparatus (e.g., the reproducing apparatus 11 shown in FIG. 1 or the personal computer 301 shown in FIG. 14) including a function of processing images. The information processing method includes obtaining bitmap data and extracting graphic pixels constituting a character or an image from the bitmap data (e.g., step S42 shown in FIG. 13); extracting pixels on the basis of circumference of circles of a predetermined radius that would be drawn from the center of the graphic pixels and regarding the pixels as extracted pixels (e.g., step S44 shown in FIG. 13); giving a predetermined pixel value to the extracted pixels (e.g., step S45 shown in FIG. 13); and combining the extracted pixels to which the pixel value has been given and the bitmap data (e.g., step S46 shown in FIG. 13).

A program according to an embodiment of the present invention is a program allowing a computer to execute a process of images. The program allows the computer to execute a process including controlling obtainment of bitmap data and extracting graphic pixels constituting a character or an image from the bitmap data (e.g., step S42 shown in FIG. 13); extracting pixels on the basis of circumference of circles of a predetermined radius that would be drawn from the center of the graphic pixels and regarding the pixels as extracted pixels (e.g., step S44 shown in FIG. 13); giving a predetermined pixel value to the extracted pixels (e.g., step S45 shown in FIG. 13); and controlling combining of the extracted pixels to which the pixel value has been given and the bitmap data (e.g., step S46 shown in FIG. 13).

Hereinafter, an embodiment of the present invention is described with reference to the drawings.

When a bitmap image in a bitmap font is superimposed on another image or a frame image constituting moving images, the bitmap image is difficult to be seen if the color of pixels constituting the bitmap image is approximate to the color of a background portion.

Such a state occurs regardless of whether the bitmap image includes characters, icons or marks, or another image, and whether the image data on which the bitmap image is superimposed is a moving image or a still image.

Particularly, when a caption is superimposed as a bitmap image on content data including audio data and video data, the state where the bitmap image is difficult to be seen can often occur because a background color changes according to various scenes.

As an example of an apparatus to which the present invention is applied, a reproducing apparatus 11 is described below. The reproducing apparatus 11 is capable of superimposing a caption or the like as a bitmap image on content data including audio data and video data.

FIG. 1 is a block diagram showing a configuration of the reproducing apparatus 11.

The reproducing apparatus 11 includes an operation input obtaining unit 31, a disc drive 32, an HDD (hard disk drive) 33, a read control unit 34, a decoder 35, a bitmap data generating unit 36, an image-with-effect generating unit 37, a buffer 38, an OSD (on screen display) 39, and an output control unit 40.

The operation input obtaining unit 31 includes key buttons, a touch pad, and a mouse used by a user to input operations, or a receiving unit to receive signals from a remote commander (not shown). The operation input obtaining unit 31 accepts an operation input from the user and supplies it to the read control unit 34, and also supplies it to the image-with-effect generating unit 37 as necessary.

The disc drive 32 drives a recording medium 12 when it is loaded thereto, reads information recorded thereon, and supplies the information to the read control unit 34. Examples of the recording medium 12 include an optical disc, a magneto-optical disc, a magnetic disc, and a semiconductor memory.

In this case, assume that content data including audio data and video data is recorded on the recording medium 12. Also, caption data for the content data is recorded on the recording medium 12. The caption data may be recorded in a form of bitmap data or text data and font data. Furthermore, additional data of the caption data is recorded on the recording medium 12 as necessary. The additional data includes information indicating a display position of the caption data and information specifying the type of an image effect, such as outline or shadow, or specifying a parameter of an outline width.

In a case where caption data included in content data is constituted by text data and font data, a technique of rasterizing caption image data corresponding to the text data based on the font data is disclosed in Japanese Unexamined Patent Application Publication No. 2006-295531, for example.

The content data may also include data corresponding to a bitmap image that is to be displayed while being superimposed on the video data, as well as the caption data.

The HDD 33 records content data including audio data and video data on a hard disk included therein. Furthermore, caption data for the content data is recorded on the hard disk. The caption data may be recorded in a form of bitmap data, or text data and font data. Also, additional data of the caption data is recorded on the hard disk as necessary. The additional data includes information indicating a display position of the caption data and information specifying the type of an image effect, such as outline or shadow, of the bitmap data in a bitmap font of the caption or specifying a parameter of an outline width. The content data recorded on the hard disk may also include data corresponding to a bitmap image that is to be displayed while being superimposed on the video data, as well as the caption data.

The read control unit 34 reads content data and information required for reproducing the content data from the disc drive 32 or the HDD 33, supplies the audio and video data and the information required for reproducing the data to the decoder 35, and also supplies information required for reproducing bitmap data, such as a caption, to be displayed while being superimposed on the video data to the bitmap data generating unit 36.

The decoder 35 decodes the audio and video data based on the audio and video data and the information required for reproducing the data supplied from the read control unit 34, and supplies the decoded video data to the OSD 39 and the decoded audio data to the output control unit 40, respectively.

The bitmap data generating unit 36 generates bitmap data based on the information required for reproducing the bitmap data, such as a caption, supplied from the read control unit 34. If the data recorded together with the content data is bitmap data, the bitmap data generating unit 36 supplies the bitmap data to the image-with-effect generating unit 37. If the data recorded together with the content data is text data and font data, the bitmap data generating unit 36 rasterizes the caption font data in order to convert it to bitmap data by using the technique disclosed in Japanese Unexamined Patent Application Publication No. 2006-295531, for example, and supplies the bitmap data to the image-with-effect generating unit 37.

When the bitmap data generating unit 36 receives information indicating a display position of the caption data and information specifying the type of an image effect, such as outline or shadow, of the bitmap data in a bitmap font of the caption or specifying a parameter of an outline width, the bitmap data generating unit 36 supplies the received information to the image-with-effect generating unit 37.

The image-with-effect generating unit 37 receives the bitmap data from the bitmap data generating unit 36, gives a predetermined effect, that is, an effect of character decoration to be given to the bitmap data (mainly the periphery thereof), to the supplied bitmap data, based on the information specifying the type of an image effect, such as outline or shadow, of the bitmap data in a bitmap font of the caption or specifying a parameter of an outline width, and then supplies the bitmap data to the buffer 38. Also, the image-with-effect generating unit 37 may receive input of a parameter of an outline width from the operation input obtaining unit 31, and perform a process based on the input. The function of the image-with-effect generating unit 37 is described below.

The buffer 38 temporarily holds the bitmap data with the predetermined effect supplied from the image-with-effect generating unit 37, and supplies the bitmap data to the OSD 39 in synchronization with display timing of the video data.

The OSD 39 superimposes the bitmap data with the predetermined effect supplied from the buffer 38 on image data of a predetermined frame of the video data supplied from the decoder 35, and supplies the data to the output control unit 40.

The output control unit 40 supplies the audio data supplied from the decoder 35 to an external speaker or the like so that voice is output therefrom, and outputs the video data supplied from the OSD 39, the bitmap data with the predetermined effect being superimposed on the video data, to a display device (not shown), so that corresponding images are displayed.

A process performed in the image-with-effect generating unit 37 is described with reference to FIG. 2.

The configuration shown in FIG. 2 may be a specific hardware block configuration of the image-with-effect generating unit 37 or may be a functional block configuration showing a function of the image-with-effect generating unit 37.

The image-with-effect generating unit 37 includes a bitmap image obtaining unit 61, an edge pixel extracting unit 62, an effect-given-pixel extracting unit 63, a pixel value giving unit 64, and a combining unit 65.

The bitmap image obtaining unit 61 receives bitmap data from the bitmap data generating unit 36 and supplies the bitmap data to the edge pixel extracting unit 62 and to the combining unit 65.

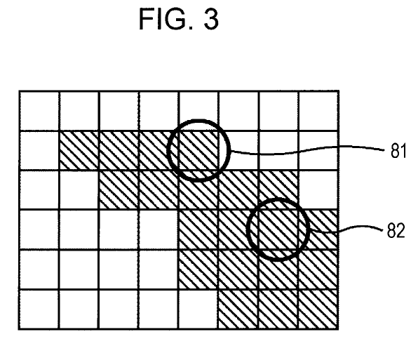

The edge pixel extracting unit 62 extracts edge pixels, which are pixel bits in an edge portion, from the supplied bitmap data. The edge pixels are part of graphic pixels (pixels constituting a character or an image) and are in contact with a portion other than the graphic pixels. More specifically, in a part of bitmap data shown in FIG. 3, a pixel 81 is in contact with, on the upper and right sides, a portion other than the graphic pixels, and is thus determined to be an edge pixel and is extracted. On the other hand, a pixel 82 is determined not to be an edge pixel because all the pixels in contact with the pixel 82 on the upper, lower, right, and left sides are graphic pixels.

The effect-given-pixel extracting unit 63 extracts pixels to be used to give an image effect, such as outline or shadow of bitmap data, based on the positions of the edge pixels extracted by the edge pixel extracting unit 62. A process performed in the effect-given-pixel extracting unit 63 is described below.

The pixel value giving unit 64 gives a predetermined pixel value, that is, a color to give an image effect, such as outline or shadow, to the pixels extracted by the effect-given-pixel extracting unit 63.

The combining unit 65 combines the bitmap image data supplied from the bitmap image obtaining unit 61 and the bitmap data with the predetermined pixel value supplied from the pixel value giving unit 64, and outputs the composite data.

Now, the process performed in the effect-given-pixel extracting unit 63 is described with reference to FIG. 4.

The configuration shown in FIG. 4 may be a specific hardware block configuration of the effect-given-pixel extracting unit 63 or may be a functional block configuration showing a function of the effect-given-pixel extracting unit 63.

The effect-given-pixel extracting unit 63 includes an edge pixel information obtaining unit 101, a circle-of-predetermined-radius drawing unit 102, a table holding unit 103, and a pixel extracting unit 104.

The edge pixel information obtaining unit 101 obtains positional information of the edge pixels extracted by the edge pixel extracting unit 62 and supplies the obtained information to the circle-of-predetermined-radius drawing unit 102.

The circle-of-predetermined-radius drawing unit 102 draws circles of a predetermined radius from the center of the respective edge pixels based on the positional information of the edge pixels. The radius of each circle may be included in a parameter that is supplied together with the bitmap data or the information to generate the bitmap data, or may be specified by an operation input by a user. The circle-of-predetermined-radius drawing unit 102 may perform a process of actually drawing circles. Alternatively, information indicating at least part of coordinates of a circle that would be drawn with a radius of a basic unit length may be stored in a form of table in the table holding unit 103, and points corresponding to the circumference of the circle may be obtained based on the coordinate information.

The table holding unit 103 holds information indicating at least part of coordinates of a circle that would be drawn with a radius of a basic unit length, in a form of table. For example, the table holding unit 103 holds part of coordinates (x, y) indicated by x=cos(θ) and y=sin(θ) (or x=α cos(θ) and y=α sin(θ) with multiplication by a predetermined coefficient α) in 0≦θ≦2π, more specifically, the coordinates (x, y) in a case where discrete θ values are substituted. Accordingly, the circle-of-predetermined-radius drawing unit 102 can easily obtain the points corresponding to the circumference of a circle that would be drawn in consideration for a radius to be drawn based on the coordinate information held in the table holding unit 103.

Alternatively, the table holding unit 103 may hold part of the coordinates (x, y) indicated by x=α cos(θ) and y=α sin(θ), more specifically, a sufficient part for easily calculating an entire part in the coordinates (x, y) in a case where discrete θ values are substituted. Specifically, as shown in FIG. 5, the table holding unit 103 may hold a table 111 showing the coordinates (x, y) satisfying x=1000×cos(θ) and y=1000×sin(θ) in the part corresponding to a first quadrant of a circle (the part corresponding to 0≦θ≦π/2). In this case, the circle-of-predetermined-radius drawing unit 102 calculates respective sums of the coordinates of the center of the edge pixel and each of coordinates (βx/1000, βy/1000), (−βx/1000, βy/1000), (βx/1000, −βy/1000), and (−βx/1000, −βy/1000), in consideration for a radius β to be drawn based on the coordinate information held in the table holding unit 103, so as to obtain the points corresponding to the circumference of the circle that would be drawn with the radius β from the center of the edge pixel.

The pixel extracting unit 104 extracts pixels to be used to give an image effect, such as outline or shadow of bitmap data, based on the circumference of the circle drawn by the circle-of-predetermined-radius drawing unit 102 or a calculation result of the points corresponding to the circumference of the circle that would be drawn.

In a case where a circle of a predetermined radius is drawn from the center of the edge pixel by the circle-of-predetermined-radius drawing unit 102, the pixel extracting unit 104 may extract a pixel if part of the pixel is included in the circle. Alternatively, the pixel extracting unit 104 may extract a pixel if an entire part of the pixel is included in the circle. Also, a predetermined threshold of 50 or 60 may be used. In that case, the pixel extracting unit 104 extracts a pixel if the predetermined percentage or more of area of the pixel is included in the circle.

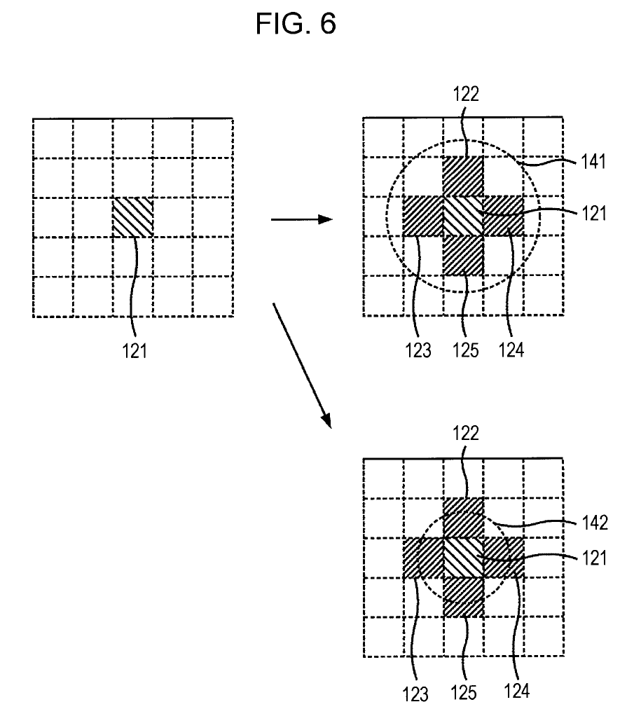

For example, as shown in FIG. 6, assume a case where a circle 141 of a predetermined radius is drawn from the center of an edge pixel 121. In this case, the pixel extracting unit 104 may extract pixels 121, 122, 123, 124, and 125 whose entire part is included in the circle 141. Also, assume a case where a circle 142 of a predetermined radius is drawn from the center of the edge pixel 121. In this case, the pixel extracting unit 104 may extract the pixels 121, 122, 123, 124, and 125 in which part or a predetermined percentage or more is included in the circle 142.

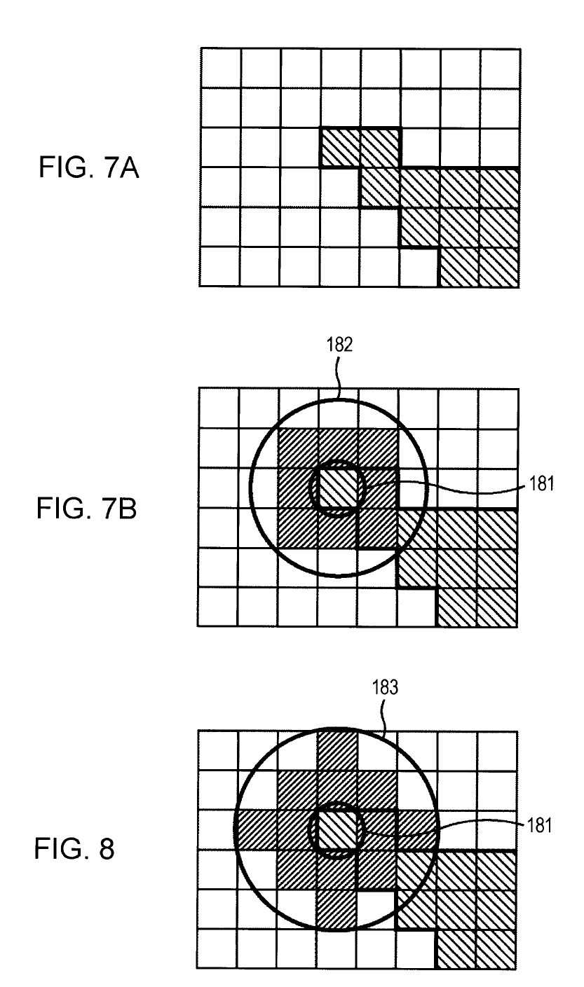

As shown in FIGS. 7A, 7B, and 8, pixels to be extracted depend on the radius of a drawn circle. For example, assume a case where pixels whose entire part is included in the drawn circle are to be extracted. As shown in FIG. 7A, when a bitmap image including graphic pixels (hatched pixels) and non-graphic pixels (non-hatched pixels) is supplied and when a circle 182 of a first radius is drawn for an edge pixel 181 as shown in FIG. 7B, the edge pixel 181 and the eight pixels on the upper, lower, right, and left sides and on the diagonals of the pixel 181 are extracted by the pixel extracting unit 104. On the other hand, as shown in FIG. 8, when a circle 183 of a second radius, which is larger than the first radius, is drawn for the edge pixel 181, the edge pixel 181, the eight pixels on the upper, lower, right, and left sides and on the diagonals of the pixel 181, and the four pixels adjacent to the pixels on the upper, lower, right, and left sides of the pixel 181, are extracted by the pixel extracting unit 104.

According to the above description, pixels constituting a character or an image in the supplied bitmap data are defined as graphic pixels. Among the graphic pixels, pixels in contact with a portion other than the graphic pixels, that is, edge pixels as pixel bits of an edge portion, are extracted by the edge pixel extracting unit 62. The effect-given-pixel extracting unit 63 draws circles of a predetermined radius from the center of the respective edge pixels and extracts pixels to be used to give an image effect, such as outline or shadow of the bitmap data. Alternatively, the edge pixels may not be extracted, but circles of a predetermined radius may be drawn from the center of all graphic pixels. In this case, too, pixels to be used to give an image effect, such as outline or shadow of the bitmap data, can be extracted.

However, the circle drawn from the center of a graphic pixel other than the edge pixels is included in the circle drawn from the center of any of the graphic pixels or edge pixels. Therefore, the process can be simplified by extracting edge pixels, drawing circles of a predetermined radius from the center of the respective edge pixels, and obtaining pixels to be painted in a predetermined color.

If a load is heavier in a process of giving a pixel value by the pixel giving unit 64, that is, in a process of painting predetermined pixels in a predetermined color, compared to a calculating process for drawing circles, the process can be simplified in the following manner. That is, a process of drawing a circle is performed on all of the graphic pixels. Among the graphic pixels, only the pixels extracted by circles of a predetermined radius drawn from the center of the edge pixels are painted in a predetermined color.

In this way, the image-with-effect generating unit 37 makes determination on each pixel of supplied bitmap data whether the pixel is an edge pixel. If the pixel is an edge pixel, the image-with-effect generating unit 37 draws a circle of a predetermined radius or obtains coordinate values through calculation equivalent to the drawing so as to extract pixels to be painted in order to give a predetermined effect to the bitmap data, and paints the extracted pixels in a predetermined color.

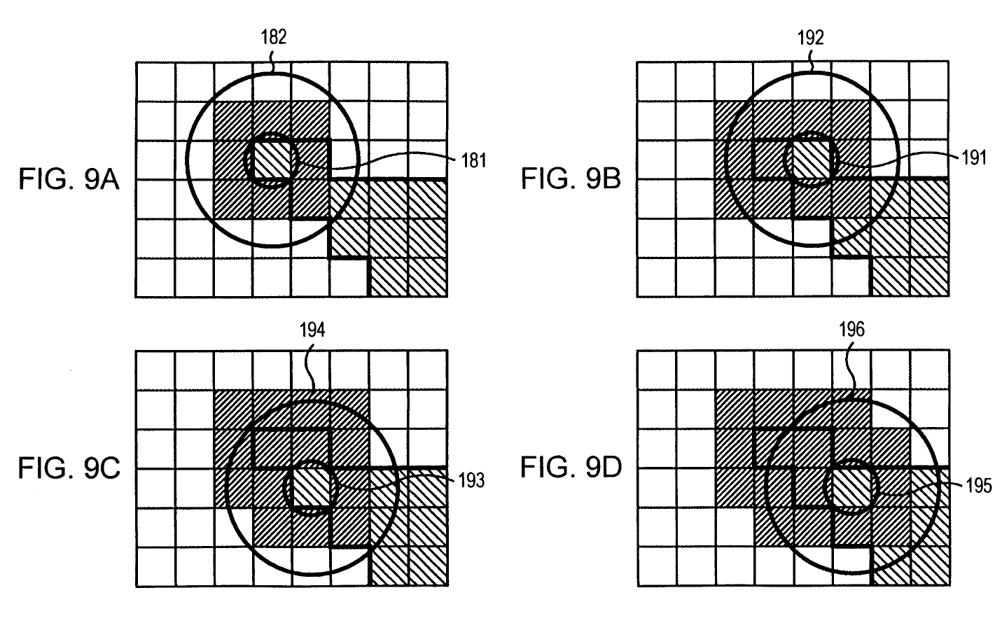

Hereinafter, a process that is repeatedly performed on respective pixels is described with reference to FIGS. 9A to 9D. Here, it is assumed that a predetermined pixel value is given to pixels whose entire part is included in a circle drawn from the center of an edge pixel, that is, the pixels are painted.

For example, in the supplied bitmap data of a predetermined range, the right direction from the upper left is regarded as a main scanning direction, and the lower direction is regarded as a sub-scanning direction. Under this condition, determination is made on each pixel whether the pixel is a graphic pixel and is an edge pixel. First, as shown in FIG. 9A, a pixel 181 is determined to be a graphic pixel and an edge pixel. Then, a circle 182 of a predetermined radius is drawn for the pixel 181, the pixel 181 and the eight pixels on the upper, lower, right, and left sides and on the diagonals of the pixel 181 are extracted by the pixel extracting unit 104, and a predetermined pixel value is given to the extracted pixels.

Then, as shown in FIG. 9B, a pixel 191 on the immediate right (in the main scanning direction) of the pixel 181 is determined to be a graphic pixel and an edge pixel. Then, a circle 192 of the predetermined radius is drawn for the pixel 191, the pixel 191 and the eight pixels on the upper, lower, right, and left sides and on the diagonals of the pixel 191 are extracted by the pixel extracting unit 104, and the predetermined pixel value is given to the extracted pixels.

Then, as shown in FIG. 9C, a pixel 193 immediately below (in the sub-scanning direction) the pixel 191 is determined to be a graphic pixel and an edge pixel. Then, a circle 194 of the predetermined radius is drawn for the pixel 193, the pixel 193 and the eight pixels on the upper, lower, right, and left sides and on the diagonals of the pixel 193 are extracted by the pixel extracting unit 104, and the predetermined pixel value is given to the extracted pixels.

Likewise, as shown in FIG. 9D, a pixel 195 on the immediate right (in the main scanning direction) of the pixel 193 is determined to be a graphic pixel and an edge pixel. Then, a circle 196 of the predetermined radius is drawn for the pixel 195, the pixel 195 and the eight pixels on the upper, lower, right, and left sides and on the diagonals of the pixel 195 are extracted by the pixel extracting unit 104, and the predetermined pixel value is given to the extracted pixels.

In this way, edge pixels are extracted from among the graphic pixels in the bitmap data, circles of a predetermined radius are drawn from the center of the respective pixels extracted as edge pixels (or coordinates are calculated so that a process equivalent to the drawing can be performed), and the pixels to which a predetermined pixel value is to be given are determined based on the circumferences of the circles.

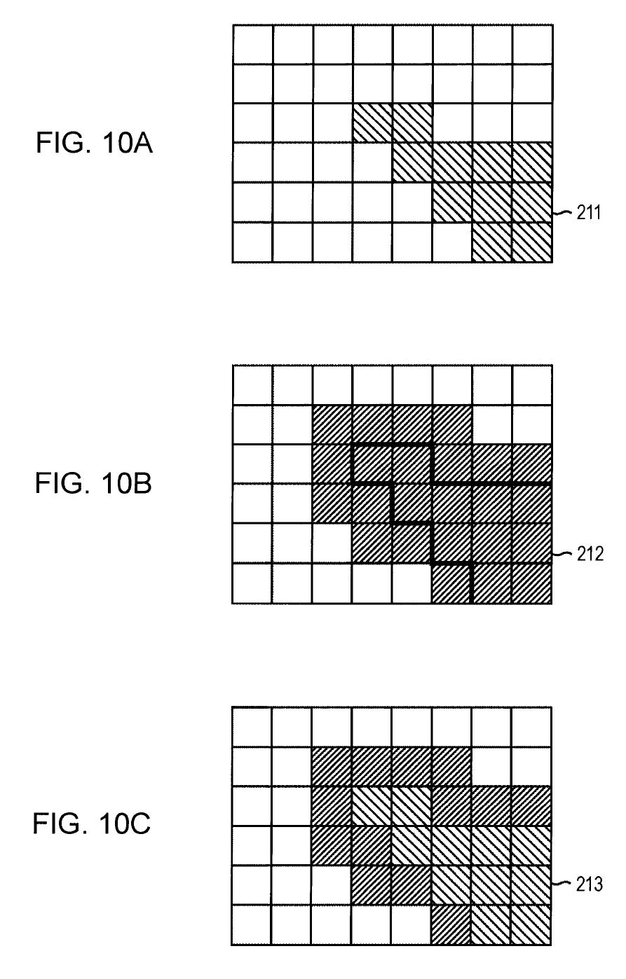

As shown in FIGS. 10A to 10C, a bitmap image 211 supplied from the bitmap image obtaining unit 61 to the combining unit 65 is combined with a bitmap image 212 supplied from the pixel value giving unit 64 to the combining unit 65 in the combining unit 65. More specifically, the pixels to which the pixel value has been given in the bitmap image 212 are overwritten with the graphic pixels in the bitmap image 211 supplied from the bitmap image obtaining unit 61 to the combining unit 65, so that a bitmap image 213 is generated.

In FIG. 10C, an outline of a predetermined color is given to the graphic pixels corresponding to the bitmap image or bitmap font. If the pixel value given by the pixel value giving unit 64 corresponds to gray, an effect of shadow can be given to the original bitmap image or bitmap font constituted by the graphic pixels. On the other hand, if the pixel value given by the pixel value giving unit 64 corresponds to a color other than white and a background color, if the original bitmap data is constituted by a bitmap font, and if the graphic pixels constituting the bitmap font have a pixel value corresponding to white, an outline character font can be obtained.

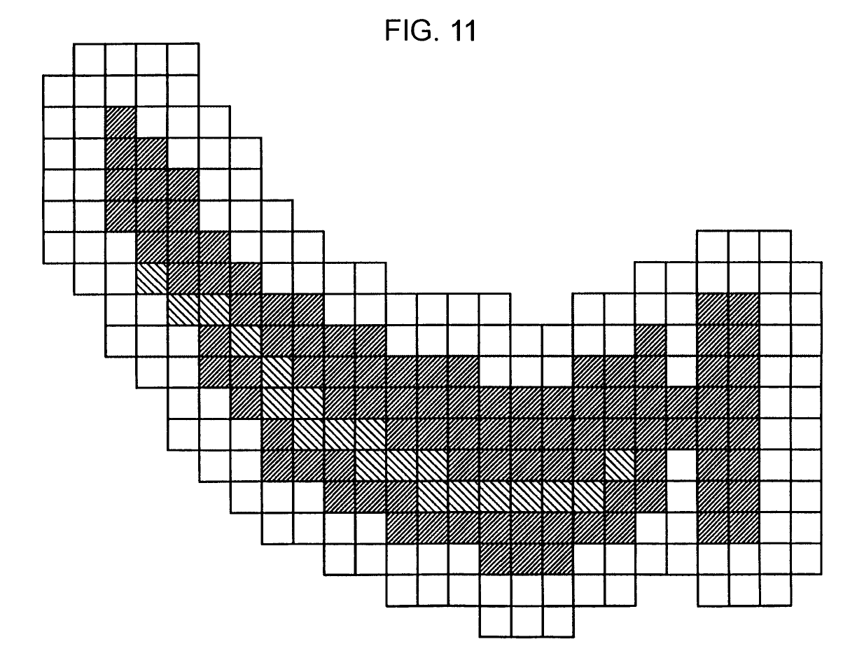

Also, even if the supplied bitmap data is not a bitmap font but is a picture having a predetermined shape shown in FIG. 11 or an icon or button, an effect of outline or shadow can be given to corresponding bitmap data in the same manner.

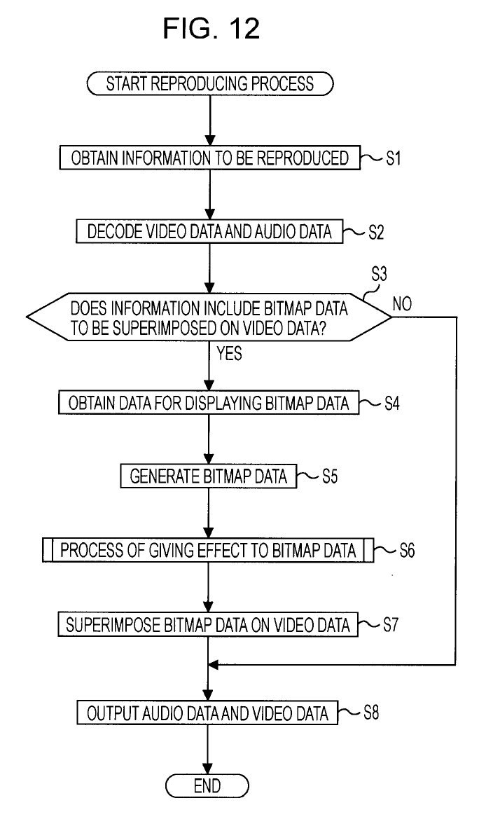

Hereinafter, a reproducing process performed in the reproducing apparatus 11 is described with reference to the flowchart shown in FIG. 12.

In step S1, the read control unit 34 obtains information to be reproduced from the loaded recording medium 12 via the disc drive 32 based on an operation input by a user obtained by the operation input obtaining unit 31, or obtains information to be reproduced from the HDD 33. The read control unit 34 supplies audio and video data and information required for reproducing the audio and video data in the obtained information to the decoder 35, and supplies information about the bitmap data to be displayed while being superimposed on the video data to the bitmap data generating unit 36.

In step S2, the decoder 35 decodes the video and audio data supplied from the read control unit 34, and supplies the video data to the OSD 39 and the audio data to the output control unit 40, respectively.

In step S3, the bitmap data generating unit 36 and the OSD 39 determine whether the information to be reproduced includes the bitmap data to be superimposed on the video data. If it is determined in step S3 that the information to be reproduced does not include the bitmap data to be superimposed on the video data, the OSD 39 supplies the supplied video data to the output control unit 40, and the process skips to step S8.

If it is determined in step S3 that the information to be reproduced includes the bitmap data to be superimposed on the video data, the process proceeds to step S4, where the bitmap data generating unit 36 obtains data required for displaying the bitmap data. The data required for displaying the bitmap data may be the bitmap data itself or may be text data and font data to generate the bitmap data. Also, data of any form, such as vector data, can be used as long as the bitmap data generating unit 36 can generate a bitmap by using the data.

In step S5, the bitmap data generating unit 36 generates the bitmap data and supplies the generated bitmap data to the image-with-effect generating unit 37. More specifically, if the data recorded together with the content data is bitmap data, the bitmap data generating unit 36 supplies the bitmap data to the image-with-effect generating unit 37. If the data recorded together with the content data is text data and font data, the bitmap data generating unit 36 rasterizes caption font data by using the technique disclosed in the Japanese Unexamined Patent Application Publication No. 2006-295531 so as to convert the data to bitmap data, and supplies the bitmap data to the image-with-effect generating unit 37.

In step S6, a process of giving an effect to bitmap data, which is described below with reference to FIG. 13, is performed.

In step S7, the buffer 38 supplies the bitmap data that is generated by the process of step S6 and is supplied from the image-with-effect generating unit 37 and that is provided with an effect of an outline or the like, as illustrated in FIGS. 10A to 10C or 11, to the OSD 39 based on output timing of the video data. The OSD 39 superimposes the bitmap data supplied from the buffer 38 on the video data supplied from the decoder 35 and supplies the data to the output control unit 40.

If it is determined in step S3 that the information to be reproduced does not include the bitmap data to be superimposed on the video data, or after step S7, the process proceeds to step S8, where the output control unit 40 outputs the audio data and the video data at the same time, and then the process ends.

With this process, the data recorded on the recording medium 12 or the HDD 33 can be reproduced. When bitmap data is to be superimposed on video data, a predetermined effect, such as outline or shadow, can be given to the bitmap data.

Hereinafter, the process of giving an effect to bitmap data, which is performed in step S6 in FIG. 12, is described with reference to the flowchart shown in FIG. 13.

In step S41, the bitmap image obtaining unit 61 of the image-with-effect generating unit 37 obtains the bitmap data from the bitmap data generating unit 36 and supplies the bitmap data to the combining unit 65 and to the edge pixel extracting unit 62. The edge pixel extracting unit 62 determines whether there is an unprocessed graphic pixel. If it is determined in step S41 that there is no unprocessed graphic pixel, the process proceeds to step S46, which is described below.

If it is determined in step S41 that there is an unprocessed graphic pixel, the process proceeds to step S42, where the edge pixel extracting unit 62 extracts the unprocessed graphic pixel as a target pixel.

In step S43, the edge pixel extracting unit 62 determines whether there are adjoining graphic pixels on all of the upper, lower, right, and left sides of the target pixel. If it is determined in step S43 that there are adjoining graphic pixels on all of the upper, lower, right, and left sides of the target pixel, the target pixels is a graphic pixel but is not an edge pixel. Thus, the process returns to step S41, and the subsequent steps are repeated.

If it is determined in step S43 that any of the adjoining pixels on the upper, lower, right, and left sides of the target pixel is not a graphic pixel, the process proceeds to step S44, where the edge pixel extracting unit 62 extracts the target pixel as an edge pixel and supplies the pixel to the effect-given-pixel extracting unit 63. The effect-given-pixel extracting unit 63 extracts pixels included in a circle of a predetermined radius that would be drawn from the center of the target pixel (the entire part, at least a part, or a predetermined percentage or more is included in the circle), and supplies the extracted pixels to the pixel value giving unit 64.

In step S45, the pixel value giving unit 64 gives a predetermined pixel value to the pixels that have been extracted by the effect-given-pixel extracting unit 63, that is, performs a process of painting the extracted pixels in a predetermined color. After step S45, the process returns to step S41, and the subsequent steps are repeated.

If it is determined in step S41 that there is no unprocessed graphic pixel, the process proceeds to step S46, where the combining unit 65 combines the bitmap image that is generated by painting and that is supplied from the pixel value giving unit 64 with the base bitmap image supplied from the bitmap image obtaining unit 61, as described above with reference to FIGS. 10A to 10C, and outputs the composite image to the buffer 38. Then, the process returns to step S6 in FIG. 12, and the process proceeds to step S7.

With this process, the outline shown in FIG. 10C can be given to the edge portion of the graphic pixels in the bitmap image. If the pixel value given by the pixel value giving unit 64 corresponds to gray, an effect of shadow can be given to the original bitmap image or bitmap font constituted by graphic pixels. On the other hand, if the pixel value given by the pixel value giving unit 64 corresponds to a color other than white and a background color and if the original bitmap image constituted by graphic pixels is a white bitmap font, an outline character font can be obtained.

As described above, in the reproducing apparatus 11 to which the present invention is applied, circles are drawn from the center of graphic pixels, and pixel bits to which an effect is to be given are extracted by using the plurality of drawn circles. Accordingly, a more natural outline effect can be given to bitmap data in a curved line or a curved portion compared to a method that has traditionally been used.

The above-described function of giving an effect of outline or shadow to a graphic pixel portion in bitmap data may be used in a typical information processing apparatus, as well as in the reproducing apparatus 11 to reproduce content.

In that case, the function of giving an effect of outline or shadow to a graphic pixel portion in bitmap data can be applied in a personal computer 301 shown in FIG. 14, for example.

In FIG. 14, a CPU (central processing unit) 311 executes various processes in accordance with a program stored in a ROM (read only memory) 312 or a program loaded from a storage unit 318 to a RAM (random access memory) 313. The RAM 313 also stores data required by the CPU 311 to execute various processes.

The CPU 311, the ROM 312, and the RAM 313 are mutually connected via a bus 314. An input/output interface 315 connects to the bus 314.

The input/output interface 315 connects to an input unit 316 including a keyboard and a mouse, an output unit 317 including a display and a speaker, a storage unit 318 including a hard disk, a communication unit 319 including a modem and a terminal adapter, and an image processing unit 320. The communication unit 319 performs a communication process via a network including the Internet.

The image processing unit 320 performs the following processes based on control by the CPU 311. That is, the image processing unit 320 performs various image processing, generates bitmap data based on information required for reproducing the bitmap data such as a caption, gives a predetermined effect, such as outline or shadow, to the bitmap data, and combines a processed image and the bitmap data to which the effect has been given.

The input/output interface 315 also connects to a drive 321 as necessary. A magnetic disc 331, an optical disc 332 (including a CD-ROM (compact disc read only memory), a DVD (digital versatile disc), and Blu-ray Disc®), a magneto-optical disc 333, or a semiconductor memory 334 is loaded thereto, and a computer program read therefrom is installed into the storage unit 318 as necessary.

By further providing a decoding function, the function of the reproducing apparatus 11 described above with reference to FIG. 1 can be realized by the personal computer 301 shown in FIG. 14.

Hereinafter, a function of the image processing unit 320 is described with reference to FIG. 15.

In FIG. 15, the parts corresponding to those in FIG. 1 are denoted by the same reference numerals, and the corresponding description is appropriately omitted.

The image processing unit 320 shown in FIG. 15 includes the bitmap data generating unit 36, the image-with-effect generating unit 37, the buffer 38, and the OSD 39 that have been described with reference to FIG. 1. Additionally, the image processing unit 320 includes an image data obtaining unit 341 and a main image processing unit 342.

The image data obtaining unit 341 obtains bitmap data or information required for generating bitmap data, and data corresponding to an image (still image or moving image) on which the bitmap data is to be superimposed from the storage unit 318, the communication unit 319, or the drive 321, supplies the bitmap data or the information required for generating the bitmap data to the bitmap data generating unit 36, and supplies the data corresponding to the image on which the bitmap data is to be superimposed to the main image processing unit 342.

The main image processing unit 342 performs a predetermined process, such as gradation conversion and brightness conversion, on the supplied image data, and supplies the image data to the OSD 39.

The personal computer 301 including the image processing unit 320 having the above-described configuration has the function of giving an effect, such as outline or shadow, to a graphic pixel portion in the bitmap data, as the above-described reproducing apparatus 11.

That is, in an information processing apparatus such as a typical personal computer, as in the above-described reproducing apparatus 11, a more natural outline than in a traditionally used method can be given to bitmap data in a curved line or a curved portion by extracting pixel bits to which an effect is to be given by drawing a plurality of circles from the center of graphic pixels by applying the present invention.

The above-described series of processes can be executed by software. In that case, a program constituting the software is installed from a program storage medium to a computer incorporated in a dedicated hardware or a multi-purpose personal computer capable of performing various functions by being installed with various programs.

The program storage medium includes a package medium that is distributed to provide a user with the program and that contains the program, such as the magnetic disc 331 (including a flexible disc), the optical disc 332 (including a CD-ROM (compact disc read only memory), a DVD (digital versatile disc), and Blu-ray Disc®), the magneto-optical disc 333 (including an MD (Mini Disc®)), or the semiconductor memory 334.

In this specification, the steps describing the program recorded on the program storage medium may be performed in time series according to the described order. Alternatively, the steps may be performed in parallel or individually.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus including a function of processing images; the information processing apparatus comprising:
bitmap data obtaining means for obtaining bitmap data;
pixel extracting means for extracting, from the bitmap data obtained by the bitmap data obtaining means, pixels on the basis of circumference of circles of a predetermined radius that would be drawn from the center of graphic pixels constituting a character or an image, and regarding the pixels as extracted pixels;
pixel value giving means for giving a predetermined pixel value to the pixels extracted by the pixel extracting means; and
first combining means for combining the extracted pixels to which the pixel value has been given by the pixel value giving means and the bitmap data obtained by the bitmap data obtaining means so as to obtain bitmap data with an effect.

2. The information processing apparatus according to claim 1, further comprising:
edge pixel extracting means for extracting, from among the graphic pixels, edge pixels each being in contact with a non-graphic pixel on at least one of four sides of upper, lower, right, and left with respect to a main scanning direction,
wherein the pixel extracting means extracts, from among the graphic pixels, pixels on the basis of circumference of the circles of a predetermined radius that would be drawn from the center of the edge pixels extracted by the edge pixel extracting means, and regards the pixels as the extracted pixels.

3. The information processing apparatus according to claim 1, further comprising:
second combining means for combining the bitmap data with an effect obtained through combining by the first combining means and other image data.

4. The information processing apparatus according to claim 1, further comprising:
bitmap data generating means for obtaining information required for generating the bitmap data and generating the bitmap data,
wherein the bitmap data obtaining means obtains the bitmap data generated by the bitmap data generating means.

5. The information processing apparatus according to claim 4,
wherein the bitmap data is bitmap font data, and
wherein the information required for generating the bitmap data is text data and font data.

6. The information processing apparatus according to claim 1,
wherein the pixel extracting means includes holding means for holding table information including information of at least part of coordinates of a circle having a radius of a basic unit length, and
wherein the pixel extracting means extracts pixels on the basis of circumference of the circles of a predetermined radius that would be drawn from the center of the graphic pixels in accordance with the table information held by the holding means.

7. The information processing apparatus according to claim 1,
wherein the pixel extracting means extracts pixels of which entire part is included in the circles of a predetermined radius that would be drawn from the center of the graphic pixels and regards the pixels as the extracted pixels.

8. The information processing apparatus according to claim 1,
wherein the pixel extracting means extracts pixels of which at least a part is included in the circles of a predetermined radius that would be drawn from the center of the graphic pixels and regards the pixels as the extracted pixels.

9. The information processing apparatus according to claim 1,
wherein the pixel extracting means extracts pixels of which a predetermined percentage or more of area is included in the circles of a predetermined radius that would be drawn from the center of the graphic pixels and regards the pixels as the extracted pixels.

10. An information processing method for an information processing apparatus including a function of processing images, the information processing method comprising:
obtaining bitmap data and extracting graphic pixels constituting a character or an image from the bitmap data;
extracting pixels on the basis of circumference of circles of a predetermined radius that would be drawn from the center of the graphic pixels and regarding the pixels as extracted pixels;
giving a predetermined pixel value to the extracted pixels; and
combining the extracted pixels to which the pixel value has been given and the bitmap data.

11. A program allowing a computer to execute a process of images, the program allowing the computer to execute a process comprising:
controlling obtainment of bitmap data and extracting graphic pixels constituting a character or an image from the bitmap data;
extracting pixels on the basis of circumference of circles of a predetermined radius that would be drawn from the center of the graphic pixels and regarding the pixels as extracted pixels;
giving a predetermined pixel value to the extracted pixels; and
controlling combining of the extracted pixels to which the pixel value has been given and the bitmap data.

12. A program storage medium containing the program according to claim 11.

13. An information processing apparatus including a function of processing images; the information processing apparatus comprising:
a bitmap data obtaining unit configured to obtain bitmap data;
a pixel extracting unit configured to extract, from the bitmap data obtained by the bitmap data obtaining unit, pixels on the basis of circumference of circles of a predetermined radius that would be drawn from the center of graphic pixels constituting a character or an image, and regard the pixels as extracted pixels;
a pixel value giving unit configured to give a predetermined pixel value to the pixels extracted by the pixel extracting unit; and
a first combining unit configured to combine the extracted pixels to which the pixel value has been given by the pixel value giving unit and the bitmap data obtained by the bitmap data obtaining unit so as to obtain bitmap data with an effect.
